(19) United States
(12) Patent Application Publication
(10) Pub. No.: US 2026/0117150 A1
(43) Pub. Date: Apr. 30, 2026

(54) DUAL CHAMBER CITRIC ACID CONCENTRATE AND DILUTION SYSTEM

(71) Applicant: THE CLOROX COMPANY, Oakland, CA (US)

(72) Inventors: Bryan Parrish, Pleasanton, CA (US); Szu-Ying Chen, Pleasanton, CA (US); Mark Pszczolkowski, Pleasanton, CA (US)

(21) Appl. No.: 18/931,633

(22) Filed: Oct. 30, 2024

(51) Int. Cl. C11D 17/04; C11D 1/02; C11D 1/76; C11D 3/20; C11D 3/48

(52) U.S. Cl. CPC C11D 17/045; C11D 1/02; C11D 1/76; C11D 3/2082; C11D 3/48; C11D 17/043

(57) ABSTRACT

A sealed concentrate cleaning product includes a first sealed container containing a first formulation and a second sealed container comprising a second formulation. The first formulation includes citric acid, a nonionic or anionic surfactant, and, optionally, a solvent, a fragrance, a colorant, water, a pH adjusting agent, or any mixture or combination thereof. The second formulation includes one or more components that are sensitive to citric acid in concentrated form. For example, the second formulation can include a solvent, a fragrance, a surfactant and, optionally, a colorant, an acid, water, a pH adjusting agent, or any mixture or combination thereof. The product further includes at least one sealing structure that covers the first opening in the first container or the second opening in the second container or both first and second openings.

### FIELD

The present invention is directed toward citric acid formulations for cleaning and antimicrobial uses.

### BACKGROUND

There is a growing desire to provide cleaning products that are safer and have less harsh ingredients that can be harmful or irritating to human health. However, such safer cleaning products must also be effective in antimicrobial efficacy, sanitization or disinfection of surfaces or environments to be treated.

In particular, formulations are desirable that deliver effective sanitization or disinfection of surfaces and that are also preferred for environmental and consumer safety. Guidelines or standards for ingredients in cleaning products that are generally recognized as safe for consumers and the environment have been established by certain governmental agencies. For example, the U.S. Environmental Protection Agency (EPA) has provided a Safer Chemical Ingredients List (SCIL), e.g., for cleaning products, set forth at https://www.epa.gov/saferchoice/safer-ingredients #scil, which helps manufacturers find safer chemical alternatives that meet the criteria under the Safer Choice Program set forth by the EPA. Citric acid, which is listed in the SCIL, is an effective antimicrobial active ingredient that can be used in cleaning products for cleaning (e.g., disinfecting and/or sanitizing) a surface or environment. The EPA has also established a program called “Design for the Environment” (“DfE”) that focuses on identifying safer sanitizing and disinfecting ingredients (including citric acid) and also sets forth a special approval process for products that meet the DfE criteria. Such products that meet this criteria can become certified as DfE products.

Given the increasing use of citric acid in cleaning products, it would be advantageous to provide a citric acid solution in concentrated form that facilitates dilution with water to form a less concentrated or dilute citric acid solution for use as a cleaning product. Thus, a small volume of a concentrated citric acid solution can be provided to form a much greater volume diluted solution that is still effective for use. However, a highly concentrated citric acid solution may not be stable for long periods of time, particularly when combined with other agents such as certain solvents and fragrances. For example, certain types of fragrances can decompose or degrade when stored for long periods of time in a concentrated solution of citric acid prior to being diluted with water.

Accordingly, it would be advantageous to provide a system in which a cleaning product can be formed from dilution of a concentrated form of citric acid while further ensuring adequate preservation and stability of certain components of the cleaning product, such as certain fragrances and other additives, prior to dilution as well as after dilution for a suitable period of time prior to use of the cleaning product.

### BRIEF SUMMARY

In accordance with embodiments described herein, a cleaning concentrate dilution system comprises a dual chamber system in which a plurality of concentrated formulations are provided, including a first formulation provided in a first chamber and comprising a concentrated citric acid, and a second formulation provided in a second chamber and comprising one or more components that are sensitive to concentrated citric acid, such as certain solvents and/or certain fragrances. The system further comprises a dispensing container that receives the first and second formulations as well as water to dilute the first and second formulations within the dispensing container.

In an example embodiment, a cleaning concentrate dilution system comprises a first sealed container containing a first formulation and a second sealed container comprising a second formulation. The first formulation comprises about 2% to about 40% by weight of citric acid, about 0.2% to about 20% by weight of a nonionic or anionic surfactant, and, optionally, a solvent, a fragrance, a colorant, water, a pH adjusting agent, or any mixture or combination thereof. The second formulation comprises about 5% to about 60% by weight of a solvent, about 20% to about 80% fragrance, a surfactant, and, optionally, a colorant, an acid, water, a pH adjusting agent, or any mixture or combination thereof. At least one sealing structure covers the first opening in the first container or the second opening in the second container or both first and second openings. The system further comprises a dispensing container having a greater volume than the first and second sealed containers combined, which is formatted to contain a stable dilute cleaning formulation comprising the first formulation, the second formulation, and tap water. The dilute cleaning formulation has a 1:8-1:36 dilution of the concentrated first and second formulations combined with the tap water.

In another example embodiment, a sealed concentrate cleaning product comprises a first sealed container containing a first formulation and a second sealed container comprising a second formulation. The first formulation comprises about 2% to about 40% by weight of citric acid, about 0.2% to about 20% by weight of a nonionic or anionic surfactant, and, optionally, a solvent, a fragrance, a colorant, water, a pH adjusting agent, or any mixture or combination thereof. The second formulation comprises about 5% to about 60% by weight of a solvent, about 20% to about 80% of a fragrance, a surfactant, and, optionally, a colorant, an acid, water, a pH adjusting agent, or any mixture or combination thereof. The product further comprises at least one sealing structure that covers the first opening in the first container or the second opening in the second container or both first and second openings.

In a further example embodiment, a sealed concentrate cleaning product comprises a first sealed container containing a first formulation and a second sealed container containing a second formulation. The first formulation comprises about 2% to about 40% by weight of citric acid, about 0.2% to about 20% by weight of a nonionic or anionic surfactant, about 5% to about 60% by weight of a first solvent, and, optionally, a fragrance, a colorant, water, a pH adjusting agent, or any mixture or combination thereof. The second formulation comprises about 20% to about 80% fragrance, a surfactant, and, optionally, a second solvent, a colorant, an acid, water, a pH adjusting agent, or any mixture or combination thereof. A sealing structure covers both the first opening in the first container and a second opening in the second container, where the sealing structure is frangible.

Embodiments described herein also include methods of facilitating the formation of a dilute cleaning formulation from the concentrated first and second formulations combined with tap water and that is shelf stable as described herein.

The above and still further features and advantages of the present invention will become apparent upon consideration of the following detailed description of specific embodiments thereof.

### DETAILED DESCRIPTION

In the following detailed description, while aspects of the disclosure are disclosed, alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used herein, are synonymous and are open-ended terms that do not exclude additional, unrecited elements or method steps. The term “consisting of”, as used herein, excludes any element or method step that is not specified in a claim. The term “consisting essentially of”, as used herein, limits the scope of a claim to specific recited elements and method steps and as well as unrecited elements and unrecited steps that do not materially affect the basic and novel characteristics of the claimed invention. The terms “a” and “an” can refer to plural elements unless clearly indicated otherwise (e.g., “an excipient” can include, one, two or more excipients).

The term “effective amount”, as used herein, generally refers to amounts described within ranges as noted herein. Also, unless indicated otherwise, the term “percentage”, as used herein, refers to a weight percent based upon a particular material that is referenced. For example, an excipient, active ingredient or component that is present in an amount of 1% of a formulation or other composition indicates that the excipient, active ingredient or other component is present in the formulation or composition as 1% by total weight of the formulation or composition. Such term is also referred to herein as “wt %” or “% by weight”. Similarly, the term “ppm” refers to parts per million on a weight/weight basis, such that, e.g., 100 ppm refers to 0.01% by weight (or 0.01 wt %). Further, the term “about” as used herein in relation to a described amount indicates that the amount can deviate or vary slightly beyond the described value by no more than 5% (e.g., “about 1% by weight” also includes a range of 0.95-1.05% by weight) while substantially maintaining the same efficacy of the formulation. In addition, the term “formulation”, as used herein (e.g., a concentrated or a dilute citric acid formulation), refers to an aqueous liquid composition including two or more ingredients or components.

The term “tap water”, as used herein, generally refers to water obtained directly from a faucet or tap, e.g., from a residential, commercial or industrial facility, in which the water is provided from a public utility or via a well (ground water) and that has not been further purified, distilled or treated in any other manner beyond the faucet or tap. This is in contrast to “treated water”, which refers to water that undergoes a process that improves the quality or consistency of the water to make it appropriate for a specific end-use. For example, treated water may be water treated to remove a wide variety of contaminants, including but not limited to: bacteria, viruses, microbes, metals, minerals, chemicals, sediment, solids and other any other suitable contaminants. Treated water includes deionized water, distilled water, reverse osmosis water, soft water, filtered water, and water which may be treated by another suitable method for removal or inactivation of contaminants. The term “water”, as used herein (without further designation), refers to both tap water and treated water.

In accordance with example embodiments, a cleaning concentrate dilution system is described herein (also referred to as a dual chamber system or a dual chamber cleaning concentrate dilution system) that can be used to form an effective cleaning solution by combining formulations from two different, separate and isolated chambers of the system with water at a specified dilution ratio to form the cleaning solution. The cleaning solution that is formed is effective in cleaning, sanitizing and/or sterilizing objects or surfaces (e.g., in residential, commercial and/or industrial environments). For example, the dual chamber system can include a first formulation in a first chamber comprising citric acid in concentrated form, while a second formulation is provided in the second chamber that is separate and isolated from the first chamber. The second formulation includes one or more components (e.g., a solvent, a fragrance, etc.) that may be sensitive and potentially subject to chemical reaction and/or degradation when combined with concentrated citric acid over a certain period of time. Each of the first formulation and second formulation includes components that are in concentrated form, since combination of the first and second formulations are diluted in water to form the cleaning solution resulting in the concentration of each component being lower than in their respective concentrated (i.e., first or second) formulation.

By maintaining separation and isolation (within different chambers) of the concentrated citric acid from components that may be sensitive to the concentrated citric acid up to the point in time of dilution with water, the resultant cleaning solution that is formed by combining all of these components is rendered effective for use for prolonged periods of time in which the sensitive components function in the intended manner within the cleaning solution for such prolonged periods of time. In particular, the first formulation can comprise a concentrated citric acid formulation that is stable for prolonged periods of time (e.g., having a shelf-life of one year or longer) prior to use and prior to activation by combination with the second formulation and water. Similarly, the second formulation can include components such as a solvent, a fragrance, a colorant, etc., where the second formulation is also stable for prolonged periods of time (e.g., having a shelf-life of one year or longer) prior to use and prior to activation by combination with the second formulation and water (due to limiting the interaction/exposure to components in the first formulation prior to use). Further still, the cleaning formulation that is formed by combination of the first and second formulations with water is also stable for prolonged periods of time (e.g., having a shelf-life of one year or longer).

The dual chamber system can comprise a single container or pod that is subdivided with any suitable interior wall or barrier into a plurality of (e.g., two) chambers that are self-contained, separated and isolated from each other within the single container or pod and where each chamber includes a different concentrated formulation as described herein. Alternatively, the dual chamber system can comprise a plurality of (e.g., two) separate containers, each of which includes a single chamber for storage of one of the concentrated formulations. The system can further comprise a cleaning product container that is suitable to receive all or portions of each concentrated formulation from the separate chambers along with water (e.g., tap water) to dilute the concentrations of components within the cleaning product container when each concentrated formulation is combined with water within the cleaning product container. The cleaning product container can have a greater volume than one or more of the chambers containing concentrated formulations.

Suitable cleaning products are effective as disinfecting and/or sanitizing products utilizing citric acid as an antimicrobial agent provided in the cleaning product in an amount ranging from about 0.1% by weight to about 10% by weight, or from about 0.1% to about 5% by weight. A concentrate that would dilute to this amount of citric acid in the cleaning product would require a much greater amount of citric acid in the concentrate. For example, to obtain a dilute citric acid cleaning product that is 1-2% by weight, with a 1:10 dilution ratio of the concentrate, would require a 10-20% by weight concentrated citric acid formulation. Even greater amounts of citric acid in the concentrated formulation may be required for greater dilution ratios. Such a heavily concentrated citric acid formulation would not be stable for extended periods of time, particularly with the addition of a particular solvent (e.g., a glycol ether or an ester based solvent), a dye, a fragrance, or other ingredient in the concentrated formulation.

It has been determined that, by separating certain components in the dilute citric acid formulation prior to dilution, effective antimicrobial, disinfectant and/or sanitizing properties can be achieved with a wide range of concentrations of citric acid in the concentrated formulations. In particular, the separation of a concentrate dilution system into a plurality (e.g., two) concentrated formulations facilitates the provision of concentrated citric acid formulations including citric acid in a wide range of concentrations, including high concentrations (e.g., 20% by weight or greater) and smaller concentrations (e.g., 5% by weight or less) while still maintaining stability of the components in each concentrated formulation.

In example embodiments, the cleaning concentrate dilution system includes a concentrated first formulation comprising the concentrated citric acid and a separate, concentrated second formulation comprising components that may be sensitive to citric acid in concentrated form including, without limitation, certain solvents, dyes and fragrances. In particular, the first formulation can include citric acid in an amount from about 2% to about 40% by weight of the first formulation (i.e., the total amount of the first and second formulations), and a nonionic and/or anionic surfactant in an amount from about 0.2% to about 20% by weight of the first formulation. The first formulation can also optionally include a solvent that is not sensitive to the citric acid in concentrated form, a fragrance that is not sensitive to the citric acid in concentrated form, a colorant, water, one or more pH adjusting agents, or any mixture or combination thereof. The second formulation can include a solvent that is sensitive to citric acid in concentrated form in an amount from about 5% to about 100% by weight of the second formulation, and a fragrance that is sensitive to concentrated citric acid in an amount from about 20% to about 80% by weight of the second formulation. The second formulation can further optionally include a colorant, an acid, water, one or more pH adjusting agents, or any mixture or combination thereof.

The first formulation, which can comprise concentrated citric acid in an amount ranging from about 1% to about 40%, or from about 2% to about 40%, or from about 5% to about 40%, or from about 10% to about 40%, or from about 20% to about 40%, or from about 30% to about 40%, or from about 30% to 35% by weight of the first formulation, allows for a very broad dilution ratio when diluted with water. In particular, the first formulation having the amount in this concentration range can be diluted with water at a dilution ratio from about 1:8 to about 1:36 to achieve a cleaning solution having the desired diluted concentration of citric acid, thus rendering the first formulation suitable for forming a cleaning solutions effective for a variety of cleaning, disinfecting or sanitizing operations.

Upon combination of the first formulation with the second formulation and the addition of water, citric acid is present in the dilute cleaning formulation in an amount ranging from about 0.1% to about 10%, for from about 0.2% to about 8%, or from about 0.3% to about 6%, or from about 0.5% to about 5% by weight of the dilute cleaning formulation.

In forming the dilute cleaning formulations as described herein, the dilution ratio can be at least 1:4, where water is added to the concentrated formulations so as to increase the total formulation volume (and also reduce the amounts in weight percentages of each component) by a factor of at least 4. For example, depending upon particular applications of use and how the concentrated formulations are provided, the 1:X dilution ratio of the concentrated formulations with water to form dilute cleaning formulation (e.g., unit volume of the combined concentrated formulations to unit volume of dilute cleaning formulation) can be from 1:4 to 1:64 or greater, such as 1:4 to 1:36, or 1:8 to 1:36, or 1:10 to 1:20, or 1:4, or 1:5, or 1:6, or 1:7, or 1:8, or 1:9, or 1:10, or 1:11, or 1:12, . . . , or 1:18, or 1:19, or 1:20, or 1:21, or 1:22, . . . , or 1:28, or 1:29, or 1:30, or 1:31, or 1:32, 1:33, 1:34, 1:35, 1:36, . . . , or 1:48, or 1:49, or 1:50, or 1:51, or 1:52, . . . , or 1:58, or 1:59, or 1:60, or 1:61, or 1:62, or 1:63, or 1:64, or even greater. Since the dilution is with water, a corresponding decrease in weight percentage of the citric acid as well as other components can be decreased by a similar ratio (e.g., a 1:10 dilution ratio will achieve about a 10× reduction in concentration as measured by weight percentage of citric acid from concentrated formulation to dilute cleaning formulation).

As noted in further detail herein, the first and second formulations can be combined in equal amounts and diluted with water to form the dilute cleaning formulation. Alternatively, one of the formulations (e.g., first formulation) can be provided in a greater amount in relation to the other formulation (e.g., second formulation) when water is added.

### Surfactants

One or more surfactants are provided in the first formulation and/or the second formulation to enhance uniform distribution, uniform wetting and/or uniform penetration properties of the formulations as well as the micro efficacy of the dilute cleaning formulation during use. In certain embodiments, the one or more surfactants are provided in only the first formulation (i.e., the formulation with concentrated citric acid). The one or more surfactants can be provided in one or both of the first and second formulations in an amount from about 0.01% to about 30%, such as from about 0.1% to about 20%, or from about 0.2% to about 20%, or from about 0.2% to about 15%, or from about 0.5% to about 15%, or from about 1% to about 15%, or from about 5% to 15%, or from about 10% to 15%, by weight of the respective (first or second) formulation. In example embodiments, an anionic surfactant can be provided in the first concentrated formulation in an amount less than 1% by weight of the first concentrated formulation, while a nonionic surfactant can be provided in the first concentrated formulation in an amount from about 10% to about 20% of the concentrated formulation.

In example embodiments, a wide variety of surfactants (e.g., anionic, cationic, nonionic, zwitterionic, and/or amphoteric) can be included in the formulation, as desired or for a particular purpose. Preferably, the one or more surfactants provided in the first formulation and/or the second formulation are anionic and/or nonionic surfactants.

Examples of suitable anionic surfactants that can be provided in the first formulation and/or the second formulation can be selected from one or more of sulfates, sulfonates, sultaines and any salts or derivatives thereof. Suitable anionic surfactants include, but are not limited to, organosulfates including methylsulfates and sulfate esters. Suitable sulfonates include both sulfonate salts and sulfonic esters. Specific examples of suitable anionic surfactants include, but are not limited to, secondary alkane sulfonate (SAS), sodium lauryl sulfate (SLS), sodium xylene sulfonate (SXS), sodium lauryl ether sulfate (SLES), ammonium lauryl sulfate (ALS), alkylbenzene sulfonates (LAS), sodium cumene sulfonate (SCS), sodium toluene sulfonate (STS), branched alkylbenzene sulfonates (BAS), and any mixtures or combinations thereof. In an example embodiment, the anionic surfactant is selected from alkyl sulfates, alkyl sulfonates including secondary alkyl sulfonates, and alkylbenzene sulfonates and any mixtures of combinations thereof. The anionic surfactant may be included in either a free acid or salt form.

Examples of suitable nonionic surfactants that can be provided in the first formulation and/or the second formulation include, without limitation, one or more of alcohol ethoxylates, alcohol propoxylates, other alcohol alkoxylates including fatty (e.g., C₆, C₈, C₁₀, or C₁₂, or higher) alcohols or other constituents that have been alkoxylated to include both ethoxy and propoxy groups (EO-PO surfactants), alkyl phosphine oxides, alkyl polysaccharides (e.g., alkyl glucosides and alkyl pentosides), alkyl glycerol esters, alkyl ethoxylates, and alkyl and alkyl phenol ethoxylates of all types, poly alkoxylated (e.g. ethoxylated or propoxylated) C₆-C₁₂ linear or branched alkyl phenols, C₆-C₂₂ linear or branched aliphatic primary or secondary alcohols, and C₂-C₈ linear or branched aliphatic glycols. Block or random copolymers of C₂-C₆ linear or branched alkylene oxides can also be suitable nonionic surfactants. Capped nonionic surfactants in which the terminal hydroxyl group is replaced by halide; C₁-C₅ linear, branched or cyclic aliphatic ether; C₁-C₅ linear, branched or cyclic aliphatic ester; phenyl, benzyl or C₁-C₄ alkyl aryl ether; or phenyl, benzyl or C₁-C₄ alkyl aryl ester can also be used. Sorbitan esters and ethoxylated sorbitan esters can also be useful nonionic surfactants.

Other suitable nonionic surfactants can include mono or polyalkoxylated amides of the formula R¹CONR²R³ and amines of the formula R¹NR²R³ wherein R¹ is a C₅-C₃₁ linear or branched alkyl group and R² and R³ are C₁-C₄ alkyl, C₁-C₄ hydroxyalkyl, or alkoxylated with 1-3 moles of linear or branched alkylene oxides. Biosoft 91-6 (Stepan Co.) is an example of an alkyl ethoxylate (or alcohol ethoxylate) having a methylene chain length of C₉ to C₁₁ with an average of 6 moles of ethoxylation. An example of an alcohol ethoxylate is ECOSURF EH-9, which is more specifically an ethylene oxide-propylene oxide copolymer mono(2-ethylhexyl) ether, available from Sigma-Aldrich. Some non-limiting examples of nonionic alkyl polysaccharide surfactants include, without limitation, a polysaccharide having a linear or branched alkyl, alkylphenyl, hydroxyalkyl, or hydroxyalkylphenyl group containing from 6 to 30 carbon atoms and a polysaccharide, e.g., a polyglycoside (e.g., an alkyl polyglycoside), a hydrophilic group containing from 1.3 to 10 saccharide units. Suitable saccharides can include, but are not limited to, glucosides, galactosides, lactosides, and fructosides. Alkyl polyglycosides can have the formula: R²O(CnH₂ₙO), (glycosyl)× wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 10. Other suitable nonionic surfactants include fatty acid saccharide esters and alkoxylated fatty acid saccharide esters such as sucrose esters, such as sucrose cocoate, and sorbitan esters, such as polyoxyethylene (20) sorbitan monooleate and polyoxyethylene (20) sorbitan monolaurate.

### Solvents

One or more solvents are provided in the first formulation and/or the second formulation, e.g., to enhance or promote solubility of one or more other components in either of the first and second formulations and/or the dilute cleaning formulation. In example embodiments, a solvent is provided in only the second concentrated formulation to minimize or prevent degradation of the solvent prior to dilution of the citric acid when forming the dilute cleaning formulation. Suitable solvents include, without limitation, alcohol solvents (e.g., mono-alcohols or glycols) and/or glycol ether solvents. Example alcohol solvents include, without limitation, ethylene glycol, propylene glycol, dipropylene glycol, triethylene glycol, hexanediol, and hexylene glycol, diethylene glycol ethyl ether, and lower alcohol solvents (e.g., C₁-C₄ mono-alcohols). Certain solvents that are sensitive to lower pH solutions (e.g., ester-based solvents) are not desirable and should therefore be avoided for use in the concentrated first formulation or even in the combined diluted formulation.

The one or more solvents can be provided in one or both of the first and second formulations in an amount from about 3% to about 70%, such as from about 5% to about 70%, or from about 5% to about 60%, or from about 5% to about 50%, or from about 10% to about 40%, or from about 10% to about 30%, or from about 10% to about 20% by weight of the respective (first or second) formulation.

### Additional Acids

In certain embodiments, one or more additional acids, in particular additional organic acids, can be provided in addition to citric acid. The one or more additional acids can be provided to enhance cleaning, disinfecting and/or sterilizing of objects or surfaces to be treated.

Some non-limiting examples of additional acids to provide in the first formulation and/or the second formulation include short chain organic acids (e.g., organic acids having no more than 12, no more than 10, no more than 8, or no more than 6 carbon atoms), including mono-organic acids, dicarboxylic acids, and polycarboxylic acids, alpha hydroxy acids, fatty acids, keto acids, dicarboxylic acids, unsaturated carboxylic acids, alkane sulfonic acids, and aromatic acids. In an example embodiment, a dilute cleaning formulation can include a combination of citric acid and methane sulfonic acid.

The one or more additional acids can be provided in the same or similar amounts as citric acid in the dilute cleaning formulation. Alternatively, the one or more additional acids can be provided in an amount less than citric acid in the dilute cleaning formulation. In example embodiments, the one or more additional acids can be provided in one or both of the first and second formulations in an amount from about 0.01% to about 20%, such as from about 0.1% to about 10%, or from about 0.1% to about 10%, or from about 0.1% to about 5%, or from about 0.5% to about 3%, or from about 0.5% to about 2% by weight of the respective (first or second) formulation.

The one or more additional acids can be provided in one or both of the first concentrated formulation and the second formulation. Preferably, the one or more additional acids are provided in the first formulation so as to ensure that components (e.g., solvents, fragrances, colorants, etc.) that may be sensitive to the one or more additional acids are isolated from these acids (similar to isolating such components from citric acid).

### Other Components

Any other one or more suitable excipients or other additives can also be provided within one or both of the first and second concentrated formulations depending upon a particular application of use.

For example, one or more fragrances can be added to one or both of the first formulation and the second formulation in any suitable amount(s) to provide an aesthetically pleasing odor or smell to the dilute cleaning formulation. Fragrance compositions that are sensitive and unstable in the presence of concentrated citric acid can be limited to the second formulation. Non-limiting examples of suitable fragrances include essential oils (e.g., from botanical or other naturally derived sources), synthetic fragrance oils and/or any other suitable type of fragrance composition that is stable at the concentration level of the concentrated and/or dilute citric acid formulations, where the fragrance compositions are preferably rendered substantially miscible in the aqueous based formulations. In example embodiments, the one or more fragrances are limited to (i.e., are only in) the second formulation, so as to increase the longevity of stability of the fragrances within the dilute cleaning formulation. Some specific and non-limiting examples of fragrances that are sensitive to concentrated citric acid and should therefore be limited to the second formulation are those that include one or more of an ester, a ketone and an aldehyde.

The one or more fragrances may be provided in one or both of the first and second formulations. In the second formulation, one or more fragrances can be provided in an amount from about 020% to about 80% by weight, such as from about 30% to about 70% by weight, or from about 40% to about 60% by weight, or from about 45% to about 55% by weight of the respective (first or second) formulation.

One or more of dyes or other colorants can be added to provide an aesthetically pleasing look for each of the first and second formulations as well as the dilute cleaning formulation. In certain embodiments, the first formulation can include a first colorant that yields a first color for the first formulation, and the second formulation can include a second colorant that yields a second color for the second formulation. The second colorant differs in color from the first colorant so as to provide a clear visual distinction between the first and second formulations. In addition, when the first and second formulations with their respective first and second colorants are combined with water to form the dilute cleaning formulation, the mixture of the first and second colorants can result in the dilute cleaning formulation having a third color that differs from the first and second colors. This provides a further visual indication to the user that the first and second formulations have been combined to form the dilute cleaning formulation. Further, the composition and amounts of the first and second colorants in their respective concentrated formulations can be selected such that the third color is achieved upon sufficient mixing of the first and second formulations in the sufficient amounts and with a sufficient amount of water (e.g., at a sufficient dilution ratio), which indicates the dilute cleaning formulation has been successfully formed and is ready for use. Dyes and/or other colorants that are sensitive and unstable in the presence of concentrated citric acid can be limited to the second formulation. Some non-limiting examples of dyes that are sensitive when combined with concentrated citric acid and should therefore be limited to the second formulation include dyes having a red color, or a pink color or a purple color. Some non-limiting examples of dyes that are stable when combined with concentrated citric acid and can therefore be provided in the first formulation including dyes having a green color or a blue color.

The one or more colorants may be provided in one or both of the first and second formulations in an amount from about 0.01% to about 5% by weight, such as from about 0.01% to about 3% by weight, or from about 0.01% to about 1% by weight, or from about 0.05% to about 1% by weight of the respective (first or second) formulation.

One or more suitable pH adjusting agents can be provided in one or both of the first and second concentrated formulations depending upon a particular pH that is desired for either of these formulations and/or the combined dilute formulation. Examples of suitable pH adjusting agents include, without limitation, alkali metal and alkaline earth salts of silicate (e.g., sodium silicate, sodium metasilicate, sodium orthosilicate, potassium silicate, potassium metasilicate, potassium orthosilicate, etc.), metasilicate, polysilicate, borate (e.g., sodium borate, potassium borate, etc.), carbonate (e.g. sodium carbonate, sodium bicarbonate, potassium carbonate, potassium bicarbonate, etc.), carbamate, phosphate (e.g., sodium phosphate, sodium polyphosphate, potassium phosphate, potassium polyphosphate, etc.), polyphosphate, pyrophosphates, triphosphates, tetraphosphates, ammonia, hydroxide, monoethanolamine, monopropanolamine, diethanolamine, dipropanolamine, triethanolamine, and/or 2-amino-2methylpropanol, and combinations or mixtures thereof. Strong alkaline pH adjusting agents, e.g., agents having a pKa that is about 15 or greater (e.g., sodium hydroxide), are not suitable for providing in the first formulation that includes concentrated citric acid. Weaker alkaline pH adjusting agents, such as those having a pKA less than 15 (e.g., sodium carbonate, which has a pKa of about 10) can be provided in the first formulation. Any suitable pH adjusting agent (e.g., strong and week alkaline pH adjusting agents) can be provided in the second formulation.

In example embodiments, the amount of one or more pH adjusting agents within one or both of the first formulation and the second formulation can be from about 0.2% to about 5.0% by weight, such as from about 0.2% to about 2.5% by weight, or from about 0.2% to about 2.0% by weight, or from about 0.5% to about 1.5% by weight, or from about 0.5 to 1% by weight of the respective (first or second) formulation.

One or more chelants can also be provided in one or both of the first and second formulations. Some non-limiting examples of suitable chelants include ethylenediamine tetra acetic acid (EDTA), diethylenetriamine penta acetic acid (DTPA), methylglycine diacetic acid (MGDA), and nitrilo triacetic acid (NTA).

The amount of water present in the combined concentrated formulations can be from about 0% to about 50% by weight, such as from less than about 1% to about 45%, or from about 25% to about 45%, or from about 30% to about 45% by weight of the respective (first or second) formulation.

As previously noted herein, the concentrated formulations can be diluted with any source of water, including tap water (i.e., water that has not been distilled or treated to remove minerals or other impurities). Depending upon the dilution ratio desired and/or configured for implementing with the concentrated formulation, the amount of water (e.g., tap water) that is within the dilute cleaning formulation can be from about 80% to about 98% by weight (i.e., by weight of the dilute cleaning formulation), or from about 85% to about 95% by weight. Thus, the majority of the formulations, both concentrated and dilute, contain water and further can contain tap water.

The pH of the first formulation, second formulation and dilute cleaning formulation can be selectively controlled based upon the amount of citric acid, optional further acid(s), and the amount and/or types of pH adjusting agents provided in the first and/or second formulations. In example embodiments, at least the concentrated first formulation (including citric acid) is prepared so as to have a pH from about 1.5 to no greater than about 4.0, e.g., a pH of about 1.99 or less. The pH of the dilute cleaning formulation is greater than that of at least the first formulation and is from about 2.0 to about 5.0, e.g., a pH of about 2.4 or greater.

As previously noted herein, the dual chamber system can comprise a single container or pod that is subdivided with any suitable interior wall or barrier into at least two chambers that are self-contained, separated and isolated from each other within the single container or pod. For example, the single container or pod can include a first chamber that stores the first formulation and a second chamber that stores the second formulation. Alternatively, the dual chamber system can comprise at least two separate containers, each of which includes a single chamber for storage of one of the concentrated formulations. For example, the system can include a first container that stores the first formulation and a second container that stores the second formulation.

The sealing structure that seals the openings of each of the first chamber and second chamber (for a dual chamber system) or a first container and a second container is formed of a suitable material that is stable, or not sensitive to the concentrated citric and/or other acids in either first or second concentrated formulation so as to not degrade or deteriorate when storing the concentrated formulations prior to being used. In example embodiments for the dual chamber system, a single sealing structure can be applied so as to cover a first opening of the first chamber containing the concentrated first formulation and a second opening of the second chamber containing the concentrated second formulation such that peeling away the single sealing structure results in opening both chambers. In a system including two separate containers, a separate scaling structure can be provided for a first opening of the first container containing the concentrated first formulation and a second opening of the second container containing the concentrated second formulation. The sealing structure for at least the first container containing the concentrated first formulation can comprise a single layer or mono layer film or a multilayer film comprising two or more layers. Either the mono layer film or the multilayer film can include at least one layer comprising one or more polymers selected from polypropylene, polyethylene (e.g., high density polyethylene, low density polyethylene and/or linear low density polyethylene), polyethylene terephthalate, polylactic acid, polyhydroxy alkanoate, polyvinyl alcohol, and bio-based polymer, compatibilizer, and/or any other polyolefin or thermoplastic which is combinable in a sealing manner with a rigid plastic component through heat, adhesive or other suitable processing step. The sealing structure can be breakable, rupturable or frangible (e.g., by application of force to the sealing structure, such as applying suitable pressure with a stylus object or the user's finger or thumb) to facilitate opening and release of each concentrated formulation from the corresponding container. Alternatively, the sealing structure can be constructed so as to be peelable from the opening in one or both containers.

The system can further comprise a cleaning product dispensing container to receive to receive some or all of each of the first and second formulations along with a select amount of water at the desired dilution ratio between each concentrated formulation and the water. The dispensing container can have a volume that is greater than one or both of the chambers or containers which store the first and second formulations. The dispensing container can facilitate sufficient mixing of the first and second formulations with water so as to achieve a relatively uniform mixture of components within the dispensing container prior to use.

In some example embodiments, the concentrated formulations can be provided in a small dual capsule, dual pod or other dual container that is divided into two chambers each of which stores a small amount of concentrated first or second formulation of no greater than about 10 ounces (about 283 grams), such as no greater than about 5 ounces (about 142 grams), or from about 0.5 ounce (about 14 grams) to about 2 ounces (about 57 grams). In such embodiments, the chambers of the dual pod or dual container are opened and the entire amount of each concentrated formulation is poured into the dispensing container for combining with water to form the dilute cleaning formulation. Thus, each dual pod or dual container is limited to a single use in which the entire contents of each chamber are dispensed within the dispensing container.

Alternatively, one or both of the first container and the second container can store an amount of concentrated formulation that is greater than a designated amount to be diluted for a given dilute cleaning formulation. For example, the first container (which stores the first formulation) and/or the second container (which stores the second formulation) can include concentrated formulation and an enclosure, e.g., in the form of a lid or cap, that also functions as a measurement vessel by filling a portion of or the entire volume of the cap with concentrated formulation for combining with the other components and water in the dispensing container. In such embodiments, the first container and/or the second container can include 5 ounces or more of concentrated formulation, where a designated smaller amount of concentrated formulation, such as 1 ounce, is combined with other components and diluted with water in the dispensing container prior to use. This facilitates forming a number (e.g., 5 or more) of dilute cleaning formulations of a certain volume within the dispensing container before the first container and/or the second container of concentrated formulation is entirely depleted (i.e., the first formulation and/or the second formulation is entirely used).

The first and second formulations can be combined in equal amounts and diluted with water to form the dilute cleaning formulation. Alternatively, one of the formulations (e.g., first formulation) can be provided in a greater amount in relation to the other formulation (e.g., second formulation) when water is added. For example, in certain embodiments, the combined concentrated formulation (which consists of the first formulation combined with the second formulation prior to the addition of water used to form the dilute cleaning formulation) can be formed such that the first formulation makes up or forms at least about 50%, or from about 55% to about 95%, or from about 70% to about 95% by weight of the combined concentrated formulation. In a specific example in which the combined concentrated formulation is 2 ounces and the first formulation comprises 90% by weight of the combined concentrated formulation, the concentrated formulation is formed by combining 1.8 ounces of the first formulation with 0.2 ounce of the second formulation (with a suitable amount of water also added based upon the selected dilution ratio to form the dilute cleaning formulation). Similarly, the weight percentages for citric acid and the other components as described herein in the combined concentration formulation (i.e., the first formulation combined with the second formulation before dilution with water) can be readily obtained based upon the ratio of first formulation to second formulation when combining with water to form the dilute cleaning formulation. For example, a 90/10 combined concentrated formulation (formed from 90% by weight first formulation and 10% by weight second formulation) that includes 40% by weight citric acid in the first formulation will result in a combined concentration formulation that includes 36% by weight citric acid. Further, when forming a dilute cleaning formulation based upon a 1:10 dilution ratio with water, the dilute cleaning formulation includes 3.6% by weight citric acid. The other components can be similarly determined based upon the given weight percentages for the respective (first or second) formulation, the ratio of first formulation to second formulation that makes up the combined concentrated formulation, and the dilution ratio of combined concentrated formulation to water.

The dispensing container, which can be of greater size/volume in relation to the first container and/or the second container, can be in any form that facilitates storage of the dilute cleaning formulation as well as delivery or dispensing of the dilute cleaning formulation in any desired manner for its intended use. For example, the dilute cleaning formulation may be used for cleaning, sanitizing and/or disinfecting an object or a surface, where the dispensing container can include enclosure structure comprising a dispenser such as a pump spray nozzle or other suitable delivery structure that facilitates delivery of the dilute cleaning formulation as a liquid stream, a spray or a mist from the dispensing container.

The concentrated first and second formulations as well as the dilute cleaning formulation formed from such concentrated formulations are rendered very stable for an extended period of time (e.g., for days) without significantly altering the citric acid amount or the degradation or decomposition of other components within the concentrated formulations and the dilute cleaning formulation, thus providing a long shelf life for the concentrated formulations prior to as well as after dilution.

For example, a first formulation including concentrated citric acid as described herein can be shelf stable such that an initial concentrated citric acid level or amount is maintained at greater than 50% of the initial concentrated citric acid amount after a period of about 48 hours and at a temperature of about 60° C. Further, components sensitive to concentrated citric acid, such as certain solvents and fragrances, are also maintained at greater than 50% of their initial concentrations after the same time period and temperature condition. A dilute cleaning formulation formed from combining the first and second formulations with water as described herein can be shelf stable such that the citric acid amount is maintained at greater than 50% of the initial dilute amount after 168 hours at 60°.

The dilute cleaning formulations as described herein are very effective in cleaning and antimicrobial/antibacterial/antiviral efficacy with regard to sanitizing or disinfecting objects or surfaces for a variety of different bacteria, fungi and/or viruses. Antibacterial and antiviral efficacy (resulting in a desirable kill/reduction) can be achieved with contact times of 10 minutes or less, and even 5 minutes or less for certain embodiments. For example, dilute cleaning formulations as described herein are effective (i.e., cause a reduction in number, e.g., at least a 3 log reduction, or at least a 5 log reduction, or even at least a 6 log reduction, or further still at least a 7 log reduction or greater) against both gram-positive and gram-negative bacteria (e.g., Escherichia coli, Clostridioides difficile, Staphylococcus aureus, Salmonella enterica, etc.) within 10 minutes of exposure. In addition, diluted cleaning compositions as described herein exhibit at least a 3 log reduction (e.g., at least a 5 log reduction, or even at least a 6 log reduction) in one or more viruses (e.g., Influenza A, Human Rotavirus, a Norovirus such as Murine Norovirus and Feline Calcivirus, etc.) within 10 minutes of exposure. The diluted cleaning compositions as described herein are further expected to provide a log reduction in Human Coronavirus within the same period of exposure since Human Coronavirus is about the same or less resistant to kill/log reduction in comparison to other viruses subjected to exposure to the compositions as noted in further detail herein.

In use, a user or consumer of the cleaning concentrate dilution system opens the dual chamber of a sealed container or opens first and second containers, which respectively contain the concentrated first and second formulations, and also the empty dispensing container and combines a portion or the entire amount of each of the first formulation and the second formulation with a suitable amount of water at the designated dilution ratio (e.g., from about 1:8 to about 1:36) to form a dilute cleaning formulation that is stored within the dispensing container. The dispensing container can include suitable indicia with specific numeric or other gradations/graduation marks (e.g., graduation marks, such as in ounces, printed as a graduation scale on an interior and/or exterior surface of the second container) to indicate a specified amount of concentrated formulation to add to the dispensing container (e.g., a total amount of both the first and second formulations) and then an amount of water to fill to a specific graduation mark or level in the dispensing container that achieves the desired dilution ratio. Alternatively, the volume of the dispensing container can be set so that the precise dilution ratio is achieved by adding water, after adding the concentrated first and second formulation in their set amounts, to fill the entire volume (or a substantial portion thereof) of the dispensing container. For example, for a 1:12 dilution ratio, 2 ounces of concentrated formulation (e.g., 1 ounce of first formulation and 1 ounce of second formulation for equal amounts of each, or 1.8 ounces of first formulation and 0.2 ounce of second formulation for a 90% make-up of the combined concentrated formulation being formed from the first formulation) can be added to the dispensing container, followed by filling the dispensing container with tap water to a specific level that corresponds with a graduation mark or level in the dispensing container (or filling substantially the entire volume of the dispensing container) that forms 24 ounces. Thus, the system or package facilitates easy formation of the dilute cleaning formulation by combining the concentrated first and second formulations with water at the precise amounts to achieve the precise dilution ratio and corresponding citric acid concentration as well as precise concentrations of other components within the dilute cleaning formulation that is contained within the dispensing container.

### EXAMPLES

### Example 1-Concentrated First and Second Formulations

A dual chamber system for preparing a dilute cleaning formulation includes a concentrated first formulation including citric acid and other components (e.g., one or more anionic and/or nonionic surfactants, and water), and a concentrated second formulation including a solvent and a fragrance and water that are maintained separate from the concentrated citric acid prior to being diluted with water. The first and second formulations are provided within first and second chambers of a single pod or single container. Some example combined concentrated formulations with concentration ranges of each component in the first and second formulations are set forth in the tables below:

TABLE 1
Citric Acid Dual Chamber (first combined concentrated formulation)

| | | Weight % | |
|---|---|---|---|
| | | (based upon weight percent | |
| | | of the first formulation in | |
| | | chamber 1 or the second | |
| Chamber | Component | formulation in chamber 2) | |
| 1 (makes up 90% of | Water | 45-48 | wt % |
| combined concentrated | Citric acid (anhydrous) | 37-40 | wt % |
| formulation) | Sodium lauryl sulfate | 0.2-0.6 | wt % |
| | (anionic surfactant) | | |
| | Alkyl polyglycoside | 12-16 | wt % |
| | (nonionic surfactant) | | |
| | Colorant | 0.09-0.13 | wt % |
| 2 (makes up 10% of | Water | 0.8-3 | wt % |
| combined concentrated | Propylene glycol (solvent) | 54-58 | wt % |
| formulation) | Fragrance | 41-45 | wt % |

TABLE 2
Citric Acid Dual Chamber (second combined concentrated formulation)

| | | Weight % | |
|---|---|---|---|
| | | (based upon weight percent | |
| | | of the first formulation in | |
| | | chamber 1 or the second | |
| Chamber | Component | formulation in chamber 2) | |
| 1 (makes up 90% of | Water | 45-48 | wt % |
| combined concentrated | Citric acid (anhydrous) | 37-40 | wt % |
| formulation) | Sodium lauryl sulfate | 0.2-0.6 | wt % |
| | (anionic surfactant) | | |
| | Alkyl polyglycoside | 7-11 | wt % |
| | (nonionic surfactant) | | |
| | Propylene glycol (solvent) | 4-8 | wt % |
| | Colorant | 0.09-0.13 | wt % |
| 2 (makes up 10% of | Water | 0.5-3 | wt % |
| combined concentrated | Alkyl polyglycoside | 45-48 | wt % |
| formulation) | (nonionic surfactant) | | |
| | Fragrance | 51-55 | wt % |

TABLE 3
Citric Acid Dual Chamber (third combined concentrated formulation)

| | | Weight % | |
|---|---|---|---|
| | | (based upon weight percent | |
| | | of the first formulation in | |
| | | chamber 1 or the second | |
| Chamber | Component | formulation in chamber 2) | |
| 1 (makes up 90% of | Water | 18-21 | wt % |
| combined concentrated | Citric acid (anhydrous) | 37-40 | wt % |
| formulation) | Methane sulfonic acid | 0.5-2.5 | wt % |
| | Sodium lauryl sulfate | 0.2-0.6 | wt % |
| | (anionic surfactant) | | |
| | Alkyl polyglycoside | 12-16 | wt % |
| | (nonionic surfactant) | | |
| | Diethylene glycol ethyl ether | 17-24 | wt % |
| | (solvent) | | |
| 2 (makes up 10% of | Water | 0.1-0.5 | wt % |
| combined concentrated | Colorant | 0.9-0.13 | wt % |
| formulation) | Fragrance | 41-45 | wt % |
| | Propylene glycol (solvent) | 55-56 | wt % |

The first and second formulations for each combined concentrated formulation can be combined with water to obtain a dilute cleaning formulation having any suitable citric acid concentration within the dilute formulation based upon selection of an appropriate dilution ratio of concentrated formulations to water. For example, when combining the first and second concentrated formulations at 90% by weight first concentrated formulation to 10% by weight second formulation, the combined concentrated formulation contains citric acid in an amount from about 33-36% by weight of the combined concentrated formulation. The combined concentrated formulation can be diluted with water at any dilution ratio from 1:8 to 1:36 to achieve a diluted cleaning formulation having a desired citric acid concentration (e.g., between 0.5%- 5% by weight of the diluted cleaning formulation).

### Example 2-Cleaning/Disinfecting Efficacy of Concentrate Cleaning Formulations

A cleaning formulation as described in Example 1, Table 1, was diluted with hard water after combining the first and second concentrated formulations in the amounts noted within Table 1. The dilution ratio was selected so as to achieve a concentration of citric acid within the diluted cleaning formulation that was 1.6625 wt % or 2.375 wt %. The water used to dilute the concentrated cleaning formulation was synthetic hard water containing 400 ppm calcium carbonate in accordance with AOAC standards.

Bacterial and virus efficacy tests on a surface were conducted with Staphylococcus aureus and also Human Rotavirus and Feline Calcivirus. Bacterial tests were also conducted with Staphylococcus aureus on a food surface (food sanitization efficacy testing).

For the Staphylococcus aureus surface testing, the tests were conducted in accordance with U.S. Environmental Protection Agency procedures as outlined in SOP Number MB-05-16 for antibacterial/sanitization/disinfection efficacy against Staphylococcus aureus. For each bacterial strain for the Staphylococcus aureus surface testing, 60 carriers were inoculated and treated with the diluted cleaning formulation to determine how many of the carriers were still positive after treatment over a set period of time. In these test procedures, less than 5/60 is considered a passing test (effective sanitization), while 5/60 or greater is considered as failing. All of the other tests set forth in Table 4 (including the Staphylococcus aureus food surface testing) were conducted in accordance with U.S. Environmental Protection Agency procedures as outlined in SOP Numbers MB-28-08 and MB-31-07, where the formulation (e.g., via spray) was applied to sufficiently contact a surface occupied by the noted bacterial or viral strain, and then a reduction in bacterial or viral count was measured after the noted contact time.

Test results for the various tests conducted, including citric acid concentration in the diluted cleaning formulation used in each test, are provided in Table 4:

TABLE 4
Efficacy test results

| | Citric acid | | | |
|---|---|---|---|---|
| | concentration (wt % of | Contact | | |
| Bacteria/Virus | diluted formulation | time | | Results |
| Staph. aureus (ATCC | 2.375 | 9 | minute | 0/60 (Pass) |
| 6538) surface test | | | | |
| Staph. aureus (ATCC | 1.6625 | 9 | minute | 2/60 (Pass) |
| 6538) surface test | | | | |
| Human Rotavirus (ATCC | 2.375 | 9 | minute | ≥5.25 log10 |
| VR-2018) surface test | | | | reduction (Pass) |
| Feline Calcivirus (ATCC | 2.375 | 9 | minute | 3.50 log10 reduction |
| VR-782, Strain F-9) | | | | (Pass) |
| surface test | | | | |
| Staph. Aureus (ATCC | 2.375 | 25 | seconds | 99.99999% (>7.61 |
| 6538) food contact | | | | log10) reduction |
| sanitization | | | | (Pass) |
| Staph. Aureus (ATCC | 1.6625 | 25 | seconds | 99.99999% (>7.61 |
| 6538) food contact | | | | log10) reduction |
| sanitization | | | | (Pass) |

The test results demonstrate an antibacterial/sanitizing/sterilizing/disinfecting efficacy of the dilute citric acid formulations prepared from the concentrated formulations as described herein, in which at least a 3 log reduction (e.g., at least a 5 log reduction, or at least a 6 log reduction, or at least a 7 log reduction or greater) of the bacterial or viral strain can be achieved at contact times no greater than 10 minutes, even less than 10 minutes and, in certain scenarios, in less than 1 minute.

In addition, the concentrated formulations are still effective when aged prior to and/or after being diluted and used for sanitizing, sterilizing and disinfection of bacterial and viral strains. The testing results set forth in Table 4 were conducted with aging of the concentrated first and second formulations for a period of about 4 weeks at 100° F. (about 37.8° C.), where the aging process was used to replicate a shelf life at room temperature of about 1 year. Tests were conducted both by aging before and after dilution. The efficacy tests determined that no noticeable degradation in efficacy was observed when the formulations were aged (both in concentrated and diluted forms) prior to use.

Thus, dilute hypohalite formulations as described herein are effective against both gram-positive and gram-negative bacteria within 10 minutes. For example, dilute hypohalite formulations as described herein can exhibit at least a 3 log reduction in Staphylococcus aureus population or a Salmonella enterica population within 10 minutes. Further, dilute hypohalite formulations as described herein can exhibit at least a 3 log reduction in Clostridioides difficile within 10 minutes or even within 5 minutes.

Thus, the dual chamber cleaning concentrate dilution system as described herein facilitates the formation of dilute citric acid formulations from concentrated citric acid formulations while maintaining separation of components that may be sensitive (e.g., subject to degradation or decomposition) to concentrated citric acid from the concentrated citric acid formulation. This renders the concentrated formulations as well as the dilute cleaning formulations formed from such concentrated formulations stable with suitable shelf lives while maintaining efficacy in cleaning (e.g., mold decolorization) and antimicrobial/antiviral properties over their shelf lives.

The concentrated formulations can further be diluted with tap water to form the dilute formulations without jeopardizing stability of the dilute formulations. The provision of a system that includes a dual chamber or dual container configuration to separately store at least two concentrated formulations (one of which contains the concentrated citric acid and any further concentrated acid) and an empty dispensing container also facilitates ease of conversion of the combining of the concentrated formulations to form the dilute cleaning formulation for use.

In addition, the separation of components into the first and second concentrated formulations facilitates providing components in different forms, e.g., liquid, solid, or gel. For example, a system can be provided in which one of the first and second concentrated formulations is in solid or gel form while the other is in liquid form. The combination and dilution of the two concentrated formulations with water results in a liquid (aqueous) dilute cleaning formulation. Alternatively, the first and second concentrated formulations can be provided in the same form (both in liquid, solid or gel form). When any of the first and second concentrated formulations is provided in solid or gel form, such formulations are solubilized in water during dilution to form the dilute cleaning formulation.

While the invention has been described in detail and with reference to specific embodiments thereof, it will be apparent to one skilled in the art that various changes and modifications can be made therein without departing from the spirit and scope thereof.

What is claimed:

1. A cleaning concentrate dilution system comprising:
(A) a first sealed container containing a first formulation comprising:
(i) about 2% to about 40% by weight of citric acid;
(ii) about 0.2% to about 20% by weight of a nonionic or anionic surfactant; and
(iii) optionally, a solvent, a fragrance, a colorant, water, a pH adjusting agent, or any mixture or combination thereof;
(B) a second sealed container containing a second formulation comprising:
(i) about 5% to about 60% by weight of a solvent;
(ii) about 20% to about 80% of a fragrance;
(iii) a surfactant; and
(iv) optionally, a colorant, an acid, water, a pH adjusting agent, or any mixture or combination thereof;
(C) at least one sealing structure that covers the first opening in the first container or the second opening in the second container or both first and second openings; and
(D) a dispensing container having a greater volume than the first and second sealed containers combined, which is formatted to contain a stable dilute cleaning formulation comprising:
(i) the first formulation;
(ii) the second formulation; and
(ii) a tap water;
wherein the dilute cleaning formulation has a 1:8 to 1:36 dilution of the concentrated first and second formulations combined with the tap water.

2. The concentrate dilution system of claim 1, wherein the second formulation comprises a propylene glycol solvent.

3. The concentrate dilution system of claim 1, wherein the second formulation further comprises a chelant.

4. The concentrate dilution system of claim 1, wherein the second formulation further comprises a colorant.

5. The concentrate dilution system of claim 1, wherein the first formulation comprises a nonionic surfactant.

6. The concentrate dilution system of claim 5, wherein the nonionic surfactant comprises an alkyl polyglycoside.

7. The concentrate dilution system of claim 1, wherein the first formulation comprises an anionic surfactant.

8. The concentrate dilution system of claim 7, wherein the anionic surfactant comprises a sulfate.

9. The concentrate dilution system of claim 7, wherein the first formulation contains less than 1% by weight of anionic surfactant.

10. The concentrate dilution system of claim 1, wherein the dilute cleaning formulation exhibits at least a 3-log reduction in Staphylococcus aureus population within 10 minutes.

11. The concentrate dilution system of claim 1, wherein the dilute cleaning formulation exhibits at least a 3-log reduction in Norovirus population within 10 minutes.

12. The concentrate dilution system of claim 1, wherein the sealing structure comprises a multilayer film.

13. The concentration dilution system of claim 1, wherein the dilute cleaning formulation has a 1:10 to 1:20 dilution of the concentrated first and second formulations combined with the tap water.

14. A sealed concentrate cleaning product comprising:
(A) a first sealed container containing a first formulation comprising:
(i) about 2% to about 40% by weight of citric acid;
(ii) about 0.2% to about 20% by weight of a nonionic or anionic surfactant; and
(iii) optionally, a solvent, a fragrance, a colorant, water, a pH adjusting agent, or any mixture or combination thereof;
(B) a second sealed container containing a second formulation comprising:
(i) about 5% to about 60% by weight of a solvent;
(ii) about 20% to about 80% of a fragrance;
(iii) a surfactant; and
(iv) optionally, a colorant, an acid, water, a pH adjusting agent, or any mixture or combination thereof; and
C) at least one sealing structure that covers the first opening in the first container or the second opening in the second container or both first and second openings.

15. The sealed concentrate cleaning product of claim 14, wherein the second formulation comprises a propylene glycol solvent.

16. The sealed concentrate cleaning product of claim 14, wherein the second formulation further comprises a colorant.

17. The sealed concentrate cleaning product of claim 14, wherein the first formulation comprises a nonionic surfactant.

18. The sealed concentrate cleaning product of claim 17, wherein the nonionic surfactant is an alkyl polyglycoside.

19. The sealed concentrate cleaning product of claim 14, wherein the first formulation comprises an anionic surfactant.

20. The sealed concentrate cleaning product of claim 19, wherein the anionic surfactant is a sulfate.

21. A sealed concentrate cleaning product comprising:
(A) a first sealed container containing a first formulation comprising:
(i) about 2% to about 40% by weight of citric acid;
(ii) about 0.2% to about 20% by weight of a nonionic or anionic surfactant;
(iii) about 5% to about 60% by weight of a first solvent; and
(iv) optionally, a fragrance, a colorant, water, a pH adjusting agent, or any mixture or combination thereof;
(B) a second sealed container containing a second formulation comprising:
(i) about 20% to about 80% fragrance;
(ii) a surfactant; and
(iii) optionally, a second solvent, a colorant, an acid, water, a pH adjusting agent, or any mixture or combination thereof; and
C) a sealing structure that covers both the first opening in the first container and a second opening in the second container and wherein the sealing structure is frangible.

22. The sealed concentrate cleaning product of claim 21, wherein the first formulation comprises a nonionic surfactant.

23. The sealed concentrate cleaning product of claim 21, wherein the first formulation comprises an anionic surfactant.
